(19) United States
(12) Patent Application Publication
(10) Pub. No.: US 2024/0113366 A1
(43) Pub. Date: Apr. 4, 2024

(54) METHOD FOR PRODUCING POWER STORAGE DEVICE AND POWER STORAGE DEVICE

(71) Applicants: Prime Planet Energy & Solutions, Inc., Tokyo (JP); TOYOTA JIDOSHA KABUSHIKI KAISHA, Aichi-ken (JP); PRIMEARTH EV ENERGY CO., LTD., Shizuoka-ken (JP)

(72) Inventors: Yuki SATO, Toyota-shi (JP); Yozo UCHIDA, Toyota-shi (JP); Tsuyoshi EHARA, Toyota-shi (JP); Syoichi TSUCHIYA, Toyota-shi (JP); Masataka ASAI, Toyota-shi (JP); Tsuyoshi ASANO, Toyota-shi (JP); Masahiro UCHIMURA, Toyota-shi (JP); Shigeru MATSUMOTO, Toyohashi-shi (JP); Yasuaki NAGANO, Kosai-shi (JP)

(21) Appl. No.: 18/462,408

(22) Filed: Sep. 7, 2023

(30) Foreign Application Priority Data
Oct. 4, 2022 (JP) 2022-160182

(51) Int. Cl. H01M 50/169; H01M 50/103; H01M 50/15; H01M 50/188

(52) U.S. Cl. CPC H01M 50/169; H01M 50/103; H01M 50/15; H01M 50/188

(57) ABSTRACT

A method for producing a power storage device includes forming a lid, forming a lid assembly, closing, and welding. In forming a lid, there is included forming, by forging, a protruding portion between a peripheral portion and an insertion-hole surrounding portion of the lid to block scattered light of a laser beam from being irradiated to a resin member, with a distance D from an end surface of the peripheral portion to a side surface of the protruding portion falling within 0.5t (D≤0.5t) relative to a thickness t of the lid.

### CROSS-REFERENCE TO RELATED APPLICATIONS

This application is based upon and claims the benefit of priority to Japanese Patent Application No. 2022-160182 filed on Oct. 4, 2022, the entire contents of which are incorporated herein by reference.

### BACKGROUND

### Technical Field

The present disclosure relates to a method for producing a power storage device, such as a battery or a capacitor, in which a terminal member is fixed to a case via a resin member, and a power storage device.

### Related Art

As a power storage device, there is known a rectangular battery in which positive and negative terminal members are each fixed to a case having a rectangular parallelepiped box-like shape with a resin member placed therebetween. Specifically, the case is composed of: a bottomed rectangular tube-shaped case body having a rectangular ring-shaped opening portion; and a rectangular plate-shaped lid which is laser-welded to the case body over the entire circumference to close the opening portion. In addition, the positive and negative terminal members are inserted individually in a pair of insertion holes formed in the lid and extend from the inside to the outside of the case. A pair of resin members are joined to the lid and also joined to the positive and negative terminal members while insulating between the lid and the terminal members. Examples of the conventional art are disclosed in Japanese unexamined patent application publications Nos. 2021-086813 (JP2021-086813A) and 2013-054964 (JP2013-054964A) (see FIGS. 1 and 2, etc., of JP2021-086813A and FIGS. 1 and 2, etc., of JP2013-054964A).

### SUMMARY

### Technical Problems

However, in such a battery production process, when the opening portion of the case body is closed with the lid to which the terminal members are fixed in advance, and the opening portion of the case body and a peripheral portion of the lid are laser-welded over the entire circumference, scattered light of a laser beam may be irradiated to the resin members which insulate between the lid and the terminal members, causing scorched portions on the resin members.

The present disclosure has been made in view of such circumstances, and provides a method for producing a power storage device, and the power storage device produced by this method, in which when a case body and a lid are welded by a laser to form a case, a resin member insulating between the lid and a terminal member can be prevented from formation of a scorched portion by scattered light of the laser beam.

### Means of Solving the Problems

(1) To achieve the above problems, one aspect of the present disclosure provides a method for producing a power storage device, the power storage device including: a case including a bottomed tube-shaped case body having an opening portion, and a lid that is laser-welded to the case body over an entire circumference and closes the opening portion, a terminal member inserted in an insertion hole that penetrates through the lid in a lid thickness direction, and a resin member joined to the terminal member and joined to an insertion-hole surrounding portion of the lid, which surrounds the insertion hole, while insulating between the insertion-hole surrounding portion of the lid and the terminal member, wherein the method comprises: forming the lid; forming a lid assembly that includes the lid and the terminal member integrated with the lid via the resin member, by forming the resin member by insert-molding in a state where the terminal member is inserted in the insertion hole of the lid; closing the opening portion of the case body with the lid of the lid assembly; and laser-welding the opening portion of the case body and a peripheral portion of the lid over the entire circumference to form the case by irradiating a laser beam from an outer side in the lid thickness direction of the lid, wherein forming the lid comprises: using forging, forming a protruding portion between the peripheral portion and the insertion-hole surrounding portion of the lid so as to protrude toward the outer side in the lid thickness direction to block scattered light of the laser beam irradiated to the opening portion and the peripheral portion from being irradiated to the resin member, such that the protruding portion is located at a position with a distance D from an end surface of the peripheral portion to a side surface of a proximal portion of the protruding portion on the peripheral portion side falling within 0.5t (D≤0.5t), relative to a thickness t of the lid.

The above-described method for producing the power storage device uses the lid in which the above-described protruding portion is provided between the peripheral portion and the insertion-hole surrounding portion. Accordingly, in the welding process, the scattered light of the laser beam is blocked by the protruding portion and is less likely to be irradiated to the resin member, so that formation of a scorched portion at the resin member can be prevented. In addition, since the protruding portion is formed, by forging, near the end surface of the peripheral portion of the lid (specifically, at a position with the distance D falling within 0.5t, from the end surface of the peripheral portion to the side surface of the proximal portion of the protruding portion, relative to the thickness t of the lid), the protruding portion can be formed with good accuracy.

The protruding portion of the lid may be provided, for example, between the peripheral portion and the insertion-hole surrounding portion over the entire circumference of the peripheral portion along the peripheral portion, or only at a part of the peripheral portion along the peripheral portion.

The power storage device may include for example a secondary battery such as a lithium-ion secondary battery, a capacitor such as a lithium-ion capacitor, and an all-solid-state battery.

(2) Furthermore, the above-described method for producing the power storage device described in (1) may be configured such that the opening portion of the case body has a rectangular ring shape including a pair of long-side opening portions and a pair of short-side opening portions, the peripheral portion of the lid has a rectangular ring shape including a pair of long-side peripheral portions and a pair of short-side peripheral portions, in closing the opening portion, the lid is placed to close the opening portion of the case body so that the pair of long-side peripheral portions of the lid faces the pair of long-side opening portions of the case body and the pair of short-side peripheral portions of the lid faces the pair of short-side opening portions of the case body, and the protruding portion includes a pair of protruding strip portions located one by one between the pair of long-side peripheral portions and the insertion-hole surrounding portion of the lid, the protruding strip portions extending along the long-side peripheral portions.

In this production method, the rectangular ring-shaped opening portion of the case body and the rectangular ring-shaped peripheral portion of the lid are laser-welded. In this case, the resin member provided in the lid is likely to be close to parts of the long-side peripheral portions of the peripheral portion of the lid, so that a scorched portion is apt to be formed on peripheral proximity portions, of the resin member, which are close to the long-side peripheral portions. This is because the distance over which the scattered light of the laser beam reaches to the resin member (i.e., the peripheral proximity portions) is short.

In contrast, in the above-described method for producing the power storage device, the protruding portion provided in the lid includes the protruding strip portions located between each of the long-side peripheral portions and the insertion-hole surrounding portion and extending along the long-side peripheral portions. This configuration can prevent formation of a scorched portion on the peripheral proximity portions, of the resin member, which are close to the long-side peripheral portions and thus which are particularly apt to be formed with a scorched portion.

(3) Another aspect of the present disclosure provides a power storage device comprising: a case including a bottomed tube-shaped case body having an opening portion, and a lid that is laser-welded to the case body over an entire circumference and closes the opening portion; a terminal member inserted into an insertion hole that penetrates through the lid in a lid thickness direction; and a resin member joined to the terminal member and joined to an insertion-hole surrounding portion of the lid, which surrounds the insertion hole, while insulating between the insertion-hole surrounding portion of the lid and the terminal member, wherein the lid includes a protruding portion which is located between a peripheral portion and the insertion-hole surrounding portion of the lid, which protrudes toward an outer side in the lid thickness direction, which blocks scattered light of a laser beam irradiated to the opening portion and the peripheral portion from being irradiated to the resin member, and which is formed by forging such that a distance D of the protruding portion from an end surface of the peripheral portion to a side surface of a proximal portion of the protruding portion on the peripheral portion side is within 0.5t (D≤0.5t) with respect to a thickness t of the lid, and the resin member has been prevented by the protruding portion of the lid from formation of a scorched portion.

In the above-described power storage device, the resin member has been prevented from formation of a scorched portion and thus can maintain the original appearance of the resin member, and further prevent a decrease in the insulation resistance between the lid and the terminal member through a formed scorched portion. In addition, since the protruding portion is formed, by forging, near the end surface of the peripheral portion of the lid, specifically, at a position with the distance D falling within 0.5t, from the end surface of the peripheral portion to the side surface of the proximal portion of the protruding portion, relative to the thickness t of the lid, the protruding portion is made with good accuracy.

(4) Furthermore, the power storage device described in (3) may be configured such that the opening portion of the case body has a rectangular ring shape including a pair of long-side opening portions and a pair of short-side opening portions, the peripheral portion of the lid has a rectangular ring shape including a pair of long-side peripheral portions and a pair of short-side peripheral portions, the protruding portion includes a pair of protruding strip portions located one by one between the pair of long-side peripheral portions and the insertion-hole surrounding portion of the lid, the protruding strip portions extending along the long-side peripheral portions, and the resin member has been prevented by the protruding strip portions of the lid from formation of a scorched portion at peripheral proximity portions, which are close to the long-side peripheral portions.

The above-described power storage device is configured to prevent formation of a scorched portion on the peripheral proximity portions of the resin member, which are close to the long-side peripheral portions of the lid and thus particularly apt to be formed with a scorched portion. This configuration can therefore maintain the original appearance of the resin member, at the peripheral proximity portions as well, and prevent a decrease in insulation resistance.

### BRIEF DESCRIPTION OF THE DRAWINGS

FIG. 1 is a perspective view of a battery in an embodiment;

FIG. 2 is a cross-sectional view of the battery in the embodiment, taken along a battery height direction and a battery width direction;

FIG. 3A is a partially enlarged cross-sectional view of an area around an opening portion of a case body and a peripheral portion of a lid of the battery in the embodiment, taken along the battery height direction and the battery width direction;

FIG. 3B is a partially enlarged cross-sectional view of the area around the opening portion of the case body and the peripheral portion of the lid of the battery in the embodiment, taken along the battery height direction and a battery thickness direction;

FIG. 4 is a flowchart showing a method for producing the battery in the embodiment;

FIGS. 5A and 5B are views showing a protruding portion forming step in a lid forming step in the method for producing the battery in the embodiment, respectively showing a state before a protruding strip portion is formed on the lid and a state where the protruding strip portion is formed on the lid;

FIG. 6 is a view showing a lid assembly to be formed in a lid assembly forming step of in the method for producing the battery in the embodiment;

FIG. 7 is a view showing how to close the opening portion of the case body with the lid included in the lid assembly in a closing step of the method for producing the battery in the embodiment; and

FIGS. 8A and 8B are views showing how to laser-weld the opening portion of the case body and the peripheral portion of the lid in a welding step of the method for producing the battery in the embodiment, and respectively illustrating a partially enlarged cross-section taken along the battery height direction and the battery width direction and a partially enlarged cross-section taken along the battery height direction and the battery thickness direction.

### DETAILED DESCRIPTION OF THE EXEMPLARY EMBODIMENTS

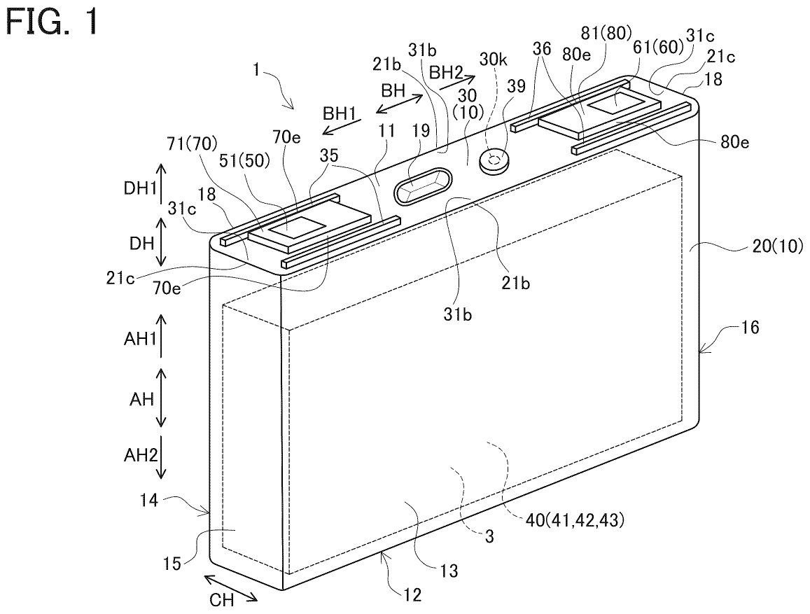

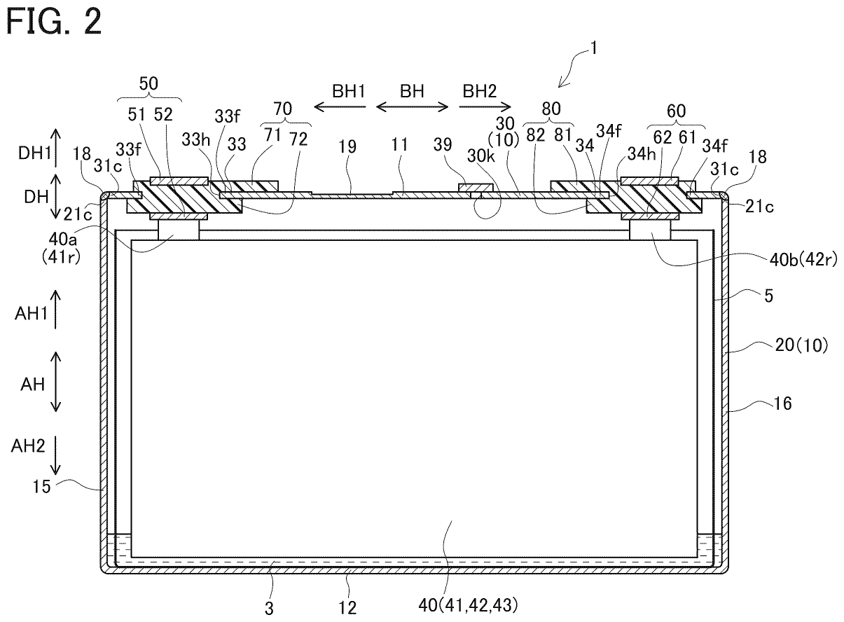

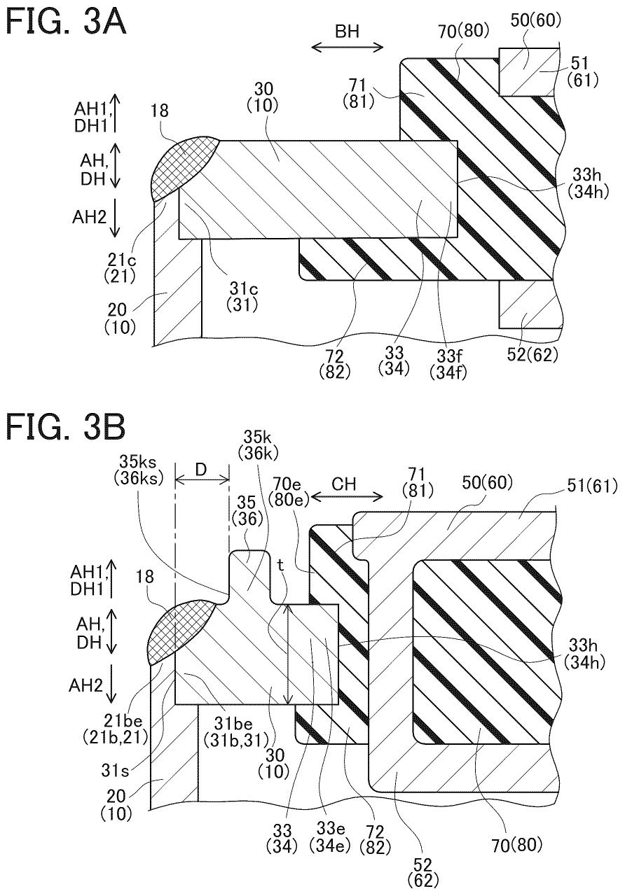

Hereinafter, an embodiment of the present disclosure will be described with reference to the drawings. FIG. 1 is a perspective view of a battery (one example of a power storage device of the present disclosure) 1 in the present embodiment. FIG. 2 is a cross-sectional view of the whole battery 1. FIGS. 3A and 3B are partially enlarged cross-sectional views of an area around an opening portion 21 of a case body 20 and a peripheral portion 31 of a lid 30 of the battery 1. The following description will be given with a battery height direction AH, a battery width direction BH, and a battery thickness direction CH of the battery 1 being defined as directions shown in FIGS. 1 to 3B. The battery 1 is a rectangular (rectangular parallelepiped-shaped) sealed lithium-ion secondary battery, which will be mounted in a vehicle, such as a hybrid car, a plug-in hybrid car, or an electric car.

The battery 1 includes a case 10, an electrode body 40 housed in the case 10, a positive terminal member 50 and a negative terminal member 60 each supported on a case top part 11 of the case 10 via resin members 70 and 80 and others. In the case 10, the electrode body 40 is covered with a bag-shaped insulating holder 5 made of an insulating film, which is open on an upper side AH1 in the battery height direction AH. In addition, the case 10 contains an electrolyte 3, a part of which is impregnated in the electrode body 40 and the rest is accumulated on a case bottom part 12 of the case 10.

The case 10 is made of a metal (aluminum in the present embodiment) in a rectangular parallelepiped box-like shape, and includes the rectangular case top part 11 located on the upper side AH1 in the battery height direction AH, the rectangular case bottom part 12 opposed to the case top part 11 and located on a lower side AH2 in the battery height direction AH, and four rectangular case side wall parts (a pair of case long-side parts 13 and 14 and a pair of case short-side parts 15 and 16) connecting the top part 11 and bottom part 12.

The case 10 includes the case body 20 and the lid 30. The case body 20 has a bottomed rectangular tube shape having the rectangular ring-shaped opening portion 21 including a pair of long-side opening portions 21b and a pair of short-side opening portions 21c on the upper side AH1 in the battery height direction AH, and forms the case bottom part 12, the case long-side parts 13 and 14, and the case short-side parts 15 and 16 of the case 10. Meanwhile, the lid 30 has a rectangular plate shape and forms the case top part 11 of the case 10. The lid 30 is laser-welded to the case body 20 over the entire circumference to close the opening portion 21 of the case body 20, and accordingly a welded portion 18 is formed between the lid 30 and the case body 20. Specifically, the pair of long-side opening portions 21b of the rectangular ring-shaped opening portion 21 of the case body 20 and a pair of long-side peripheral portions 31b of the rectangular ring-shaped peripheral portion 31 of the lid 30 are welded to each other to form the welded portion 18 (see FIG. 3B). Also, the pair of short-side opening portions 21c of the opening portion 21 of the case body 20 and a pair of short-side peripheral portions 31c of the peripheral portion 31 of the lid 30 are welded to each other to form the welded portion 18 (see FIG. 3A).

The lid 30 is provided with a safety valve 19 which breaks and opens when the internal pressure of the case 10 exceeds a valve opening pressure. The lid 30 also has a liquid inlet 30k formed so as to communicate between the inside and the outside of the case 10, and the liquid inlet 30k is hermetically sealed with a disc-shaped sealing member 39 made of aluminum. The lid 30 is provided with rectangular insertion holes 33h and 34h, which are located near an end portion on one side BH1 and near an end portion on the other side BH2 in the battery width direction BH, respectively, and penetrate in a lid thickness direction DH. The positive terminal member 50 made of aluminum is inserted in the insertion hole 33h and fixed to the lid 30 via the resin member 70 so that the terminal member 50 is insulated from the lid 30. In addition, the negative terminal member 60 made of copper is inserted in the other insertion hole 34h and fixed to the lid 30 via the resin member 80 so that the terminal member 60 is insulated from the lid 30.

These terminal members 50 and 60 respectively have rectangular plate-shaped outer terminal portions 51 and 61 placed on the lid 30, and inner terminal portions 52 and 62 placed mainly inside the case 10 and continuous to the outer terminal portions 51 and 61 through the insertion holes 33h and 34h of the lid 30. The positive inner terminal portion 52 is joined and electrically conductive to a positive electrode tab 40a of the electrode body 40 in the case 10. Meanwhile, the negative inner terminal portion 62 is joined and electrically conductive to a negative electrode tab 40b of the electrode body 40 in the case 10.

The resin member 70 is joined to the positive terminal member 50 and a rectangular ring-shaped insertion-hole surrounding portion 33, which surrounds the insertion hole 33h of the lid 30 and which has a pair of long-side surrounding portions 33e and a pair of short-side surrounding portions 33f, while insulating between the insertion-hole surrounding portion 33 of the lid 30 and the positive terminal member 50. Similarly, the resin member 80 is joined to the negative terminal member 60 and a rectangular ring-shaped insertion-hole surrounding portion 34, which surrounds the insertion hole 34h of the lid 30 and which has a pair of long-side surrounding portions 34e and a pair of short-side surrounding portions 34f, while insulating between the insertion-hole surrounding portion 34 of the lid 30 and the negative terminal member 60.

These resin members 70 and 80 are made of polyphenylene sulfide (PPS), and respectively have rectangular plate-shaped outer insulating portions 71 and 81 placed on the lid 30, and inner insulating portions 72 and 82 placed inside the case 10 and in the insertion holes 33h and 34h of the lid 30 and continuous to the outer insulating portions 71 and 81. The outer insulating portions 71 and 81 insulate between the outer terminal portions 51 and 61 of the terminal members 50 and 60 and the insertion-hole surrounding portions 33 and 34 of the lid 30, respectively. Meanwhile, the inner insulating portions 72 and 82 insulate between the inner terminal portions 52 and 62 of the terminal members 50 and 60 and the insertion-hole surrounding portions 33 and 34 of the lid 30, respectively.

In the lid 30, a pair of protruding strip portions (protruding portions) 35 are provided one by one between the pair of long-side surrounding portions 33e of the insertion-hole surrounding portion 33 for the positive terminal member 50 and a pair of opposing long-side peripheral portions 31be, close to the long-side surrounding portions 33e, of the pair of long-side peripheral portions 31b of the peripheral portion 31 so as to protrude toward an outer side DH1 in the lid thickness direction DH (i.e., the upper side AH1 in the battery height direction AH) and extend in a straight manner in the battery width direction BH along the long-side peripheral portions 31b (opposing long-side peripheral portions 31be), respectively (see FIGS. 1 and 3B). In addition, in the lid 30, a pair of protruding strip portions (protruding portions) 36 are provided one by one between the pair of long-side surrounding portions 34e of the insertion-hole surrounding portion 34 for the negative terminal member 60 and a pair of opposing long-side peripheral portions 31be, close to the long-side surrounding portions 34e, of the pair of long-side peripheral portions 31b of the peripheral portion 31 so as to protrude toward the outer side DH1 in the lid thickness direction DH (the upper side AH1 in the battery height direction AH) and extend in a straight manner in the battery width direction BH along the long-side peripheral portions 31b.

These protruding strip portions 35 and 36 are formed near an end surface 31s of the peripheral portion 31 of the lid 30 by forging as described later. Specifically, the protruding strip portions 35 and 36 are each formed at a position so that a distance D from the end surface 31s of the peripheral portion 31 to a side surface 35ks or 36ks on the peripheral portion 31 side (the left side in FIG. 3B) of a proximal portion 35k or 36k of the protruding strip portion 35 or 36 is within 0.5t (D≤0.5t, in the present embodiment, D=0.5t) relative to a thickness t of the lid 30.

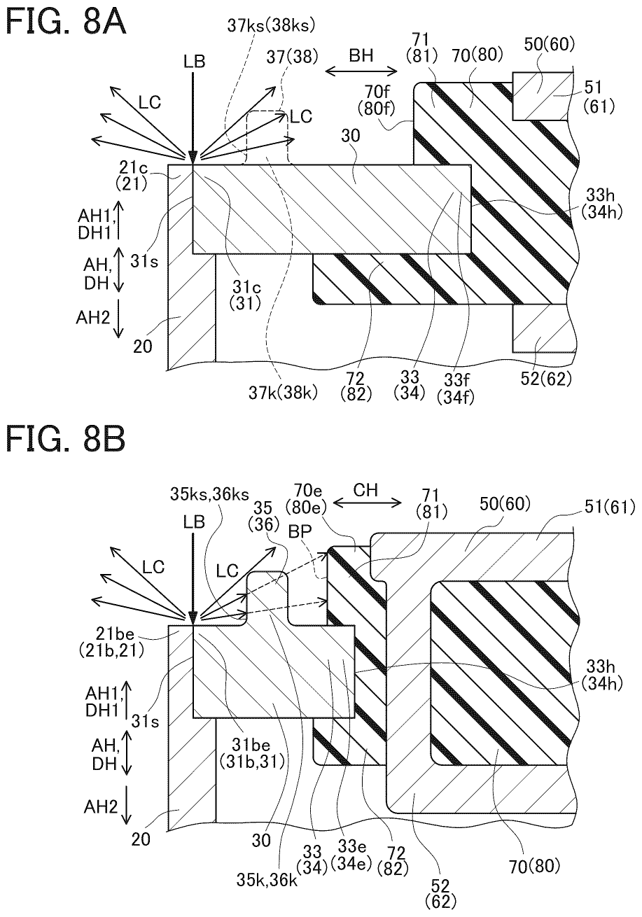

These protruding strip portions 35 and 36 block scattered light LC of a laser beam LB, which is irradiated to the opening portion 21 of the case body 20 and the peripheral portion 31 of the lid 30 when the case 10 is formed by laser-welding as described later, from being irradiated, or from traveling, to the resin members 70 and 80. These protruding strip portions 35 and 36 can thus prevent a scorched portion BP (see FIG. 8B) from forming on the resin members 70 and 80 in the battery 1 of the present embodiment.

The electrode body 40 is a laminated electrode body having a flat, rectangular parallelepiped box-like shape, in which a plurality of positive electrode plates 41 and a plurality of negative electrode plates 42, each having a rectangular shape and extending in the battery height direction AH and the battery width direction BH, are alternately stacked in the battery thickness direction CH with separators 43 composed of a porous resin membrane interposed therebetween. Each of the positive electrode plates 41 has a positive current collecting portion 41r extending upward on the upper side AH1, and the respective positive current collecting portions 41r overlap each other in the thickness direction thereof to form the above-described positive electrode tab 40a. The positive electrode tab 40a is connected to the inner terminal portion 52 of the positive terminal member 50 as described above. In addition, each of the negative electrode plates 42 has a negative current collecting portion 42r extending upward on the upper side AH1, and the respective negative current collecting portions 42r overlap each other in the thickness direction thereof to form the above-described negative electrode tab 40b. The negative electrode tab 40b is connected to the inner terminal portion 62 of the negative terminal member 60 as described above.

In the battery 1 of the present embodiment, the protruding strip portions 35 and 36 prevent a scorched portion BP from forming on the resin members 70 and 80, and thus the original appearance of the resin members 70 and 80 can be maintained, and further a decrease in the insulation resistance between the lid 30 and the terminal members 50 and 60 through a formed scorched portion BP can be prevented. In particular, in the present embodiment, the resin members 70 and 80 can also be prevented from the formation of a scorched portion BP even at peripheral proximity portions 70e and 80e which are proximate to the opposing long-side peripheral portions 31be of the long-side peripheral portions 31b and are apt to be formed with a scorched portion BP. Therefore, the resin members 70 and 80 can also maintain the original appearance of the peripheral proximity portions 70e and 80e and thus can prevent a decrease in insulation resistance.

Since the protruding strip portions 35 and 36 are each formed, by forging, near the end surface 31s of the peripheral portion 31 of the lid 30, concretely, at the position with the distance D falling within 0.5t, from the end surface 31s of the peripheral portion 31 to the side surface 35ks or 36ks of the proximal portion 35k or 36k of the protruding strip portion 35 or 36, relative to the thickness t of the lid 30, the protruding strip portions 35 and 36 are made with good accuracy.

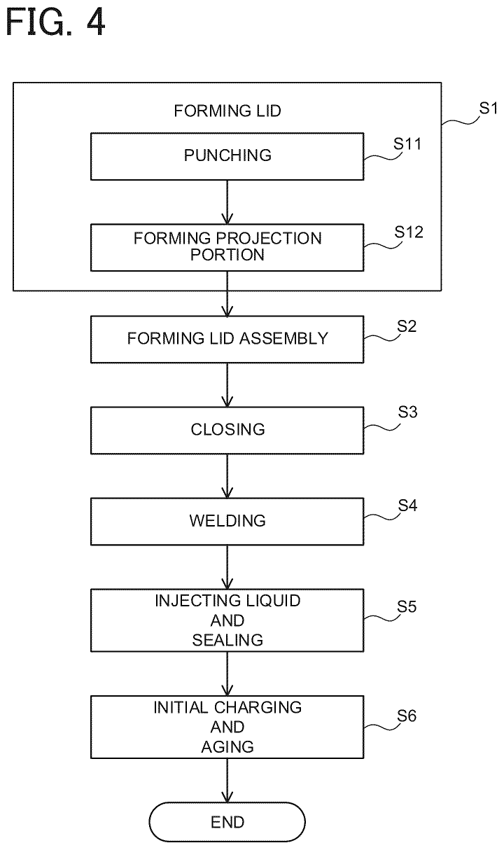

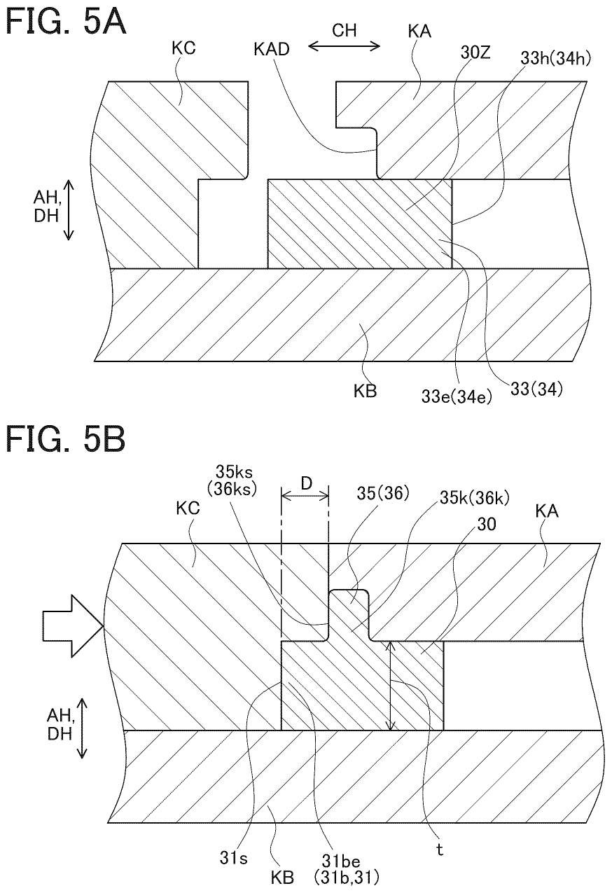

Next, a method for producing the above battery 1 will be described below (see FIGS. 4 to 8B). First, in a lid forming step S1 (see FIG. 4), the lid is formed. That is, first, in a punching step S11 of the lid forming step S1, an aluminum plate is prepared and punched into a rectangular shape by a press, and the safety valve 19, the liquid inlet 30k, and the insertion holes 33h and 34h are formed therein, completing a lid 30Z (see FIG. 5A) which does not have the protruding strip portions 35 and 36.

Then, in a protruding portion forming step S12 of the lid forming step S1, the protruding strip portions 35 and 36 are formed in the lid 30Z by forging, completing the lid 30 (see FIGS. 5A and 5B). Specifically, as shown in FIG. 5A, the lid 30Z formed as above is sandwiched between a first mold KA and a second mold KB in the lid thickness direction DH. The first mold KA is provided with step portions KAD for forming the protruding strip portions 35 and 36.

Subsequently, a third mold KC is moved rightward in FIG. 5B toward the lid 30Z and the first mold KA, and is struck against the end surface 31s of the peripheral portion 31 of the lid 30Z to plastically deform the peripheral portion 31 of the lid 30Z and its surrounding area. Thus, the protruding strip portions 35 and 36 are formed protruding into the spaces between the third mold KC and the step portions KAD of the first mold KA. As described above, the protruding strip portions 35 and 36 are each formed at the position with the distance D from the end surface 31s of the peripheral portion 31 to the side surface 35ks or 36ks of the proximal portion 35k or 36k of the protruding strip portion 35 or 36 falling within 0.5t (D≤0.5t, in the present embodiment, D=0.5t) relative to the thickness t of the lid 30. Thus, the lid 30 is completed with the protruding strip portions 35 and 36 made with high accuracy.

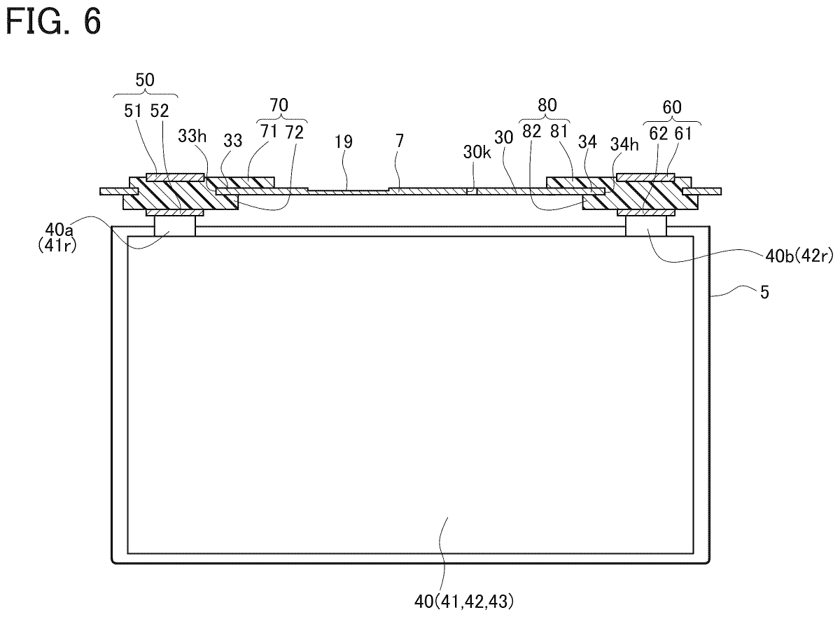

In a lid assembly forming step S2 (see FIG. 4), a lid assembly 7 is formed (see FIG. 6). That is, the terminal members 50 and 60 are further prepared, and the resin members 70 and 80 are formed by insert-molding to integrate the terminal members 50 and 60 with the lid 30 via the resin members 70 and 80 respectively. Specifically, the positive terminal member 50 is produced from an aluminum plate by press working, and the negative terminal member 60 is produced from a copper plate by press working. Then, with the terminal members 50 and 60 inserted in the insertion holes 33h and 34h of the lid 30, the resin members 70 and 80 are formed by insert-molding to integrate the terminal members 50 and 60 with the lid 30 via the resin members 70 and 80.

Then, the electrode body 40 formed by stacking the positive electrode plates 41, the negative electrode plates 42, and the separators 43 is prepared, and the inner terminal portions 52 and 62 of the terminal members 50 and 60 integrated with the lid 30 are welded and connected to the positive electrode tab 40a and the negative electrode tab 40b of the electrode body 40, respectively. Further, the electrode body 40 is enclosed in the bag-shaped insulating holder 5. Thus, the lid assembly 7 composed of the lid 30, the terminal members 50 and 60, the resin members 70 and 80, the electrode body 40, and the insulating holder 5 is completed.

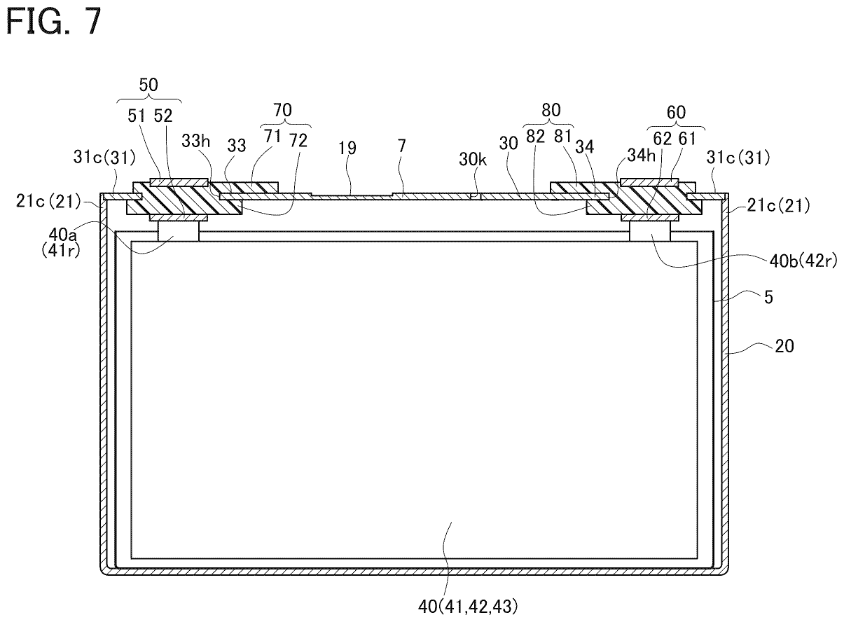

In a closing step S3 (see FIG. 4), the case body 20 is prepared, the electrode body 40, covered with the insulating holder 5, of the lid assembly 7 is inserted into the case body 20, and the opening portion 21 of the case body 20 is closed with the lid 30 (see FIG. 7). Specifically, the lid 30 is placed to close the opening portion 21 of the case body 20 such that the pair of long-side peripheral portions 31b of the peripheral portion 31 of the lid 30 faces the pair of long-side opening portions 21b of the opening portion 21 of the case body 20, and the pair of short-side peripheral portions 31c of the peripheral portion 31 of the lid 30 faces the pair of short-side opening portions 21c of the opening portion 21 of the case body 20.

In a welding step S4 (see FIG. 4), laser welding is performed over the entire circumference of the lid 30 by irradiating the laser beam LB onto the opening portion 21 of the case body 20 and the peripheral portion 31 of the lid 30 from above on an outer side DH1 in the lid thickness direction DH of the lid 30 (i.e., the upper side AH1 in the battery height direction AH), completing the case 10 (see FIGS. 8A and 8B).

Since the protruding strip portions 35 and 36 are provided, protruding upward on the outer side DH1 in the lid thickness direction DH (the upper side AH1 in the battery height direction AH), between the peripheral portion 31 and the insertion-hole surrounding portions 33 and 34 in the lid 30, during the laser welding, those protruding strip portions 35 and 36 can block the scattered light LC of the laser beam LB, which is irradiated to the opening portion 21 and the peripheral portion 31, from traveling to the resin members 70 and 80.

In detail, as shown in FIG. 8B, the distances between the insertion-hole surrounding portions 33 and 34 of the lid 30 and the peripheral portion 31 of the lid 30 and between the insertion-hole surrounding portions 33 and 34 of the lid 30 and the opening portion 21 of the body 20 are respectively the shortest between the long-side surrounding portions 33e and 34e of the insertion-hole surrounding portions 33 and 34 and the opposing long-side peripheral portions 31be of the long-side peripheral portions 31b of the peripheral portion 31 and between the long-side surrounding portions 33e and 34e of the insertion-hole surrounding portions 33 and 34 and the opposing long-side opening portions 21be of the long-side opening portions 21b of the opening portion 21, located opposite the long-side surrounding portions 33e and 34e. Therefore, if the protruding strip portions 35 and 36 are not provided, the scattered light LC of the laser beam LB is irradiated to the peripheral proximity portions 70e and 80e of the resin members 70 and 80, which are opposite and close to the opposing long-side peripheral portions 31be of the peripheral portion 31 and the opposing long-side opening portions 21be of the opening portion 21, as shown by broken line arrows in FIG. 8B, and thus a scorched portion BP is likely to be formed on the peripheral proximity portions 70e and 80e.

In contrast, in the lid 31 in the present embodiment, the protruding strip portions 35 are provided one between each of the long-side surrounding portions 33e of the insertion-hole surrounding portion 33 and the opposing long-side peripheral portions 31be of the long-side peripheral portions 31b of the peripheral portion 31. Similarly, the protruding strip portions 36 are provided one between each of the long-side surrounding portions 34e of the insertion-hole surrounding portion 34 and the opposing long-side peripheral portions 31be of the long-side peripheral portions 31b of the peripheral portion 31. With this configuration, the scattered light LC of the laser beam LB irradiated to the opposing long-side peripheral portions 31be of the long-side peripheral portions 31b of the peripheral portion 31 and the opposing long-side opening portions 21be of the long-side opening portions 21b of the opening portion 21 can be blocked from being irradiated, or from traveling, to the peripheral proximity portions 70e and 80e of the resin members 70 and 80. This can prevent formation of any scorched portion BP on the peripheral proximity portions 70e and 80e of the resin members 70 and 80.

The distances from each of the insertion-hole surrounding portions 33 and 34 of the lid 30 to the peripheral portion 31 of the lid 30 and to the opening portion 21 of the case body 20 are sufficiently long (see also FIG. 8A), except for the distances from each of the long-side surrounding portions 33e and 34e of the insertion-hole surrounding portions 33 and 34 to each of the opposing long-side peripheral portions 31be of the peripheral portion 31 and to each of the opposing long-side opening portions 21be of the opening portion 21. Therefore, even when protruding strip portions are not provided to block the scattered light LC of the laser beam LB, a scorched portion BP is less likely to be formed on the resin members 70 and 80. Therefore, in the present embodiment, as described above, the protruding strip portions 35 and 36 are provided only between the long-side surrounding portions 33e and 34e of the insertion-hole surrounding portions 33 and 34 and the opposing long-side peripheral portions 31be of the long-side peripheral portions 31b of the peripheral portion 31 in the lid 30.

In a liquid injecting and sealing step S5, subsequently, the electrolyte 3 is injected into the case 10 through the liquid inlet 30k so that the electrode body 40 is impregnated therewith. Then, the liquid inlet 30k is covered with the sealing member 39 from the outside, and the sealing member 39 is welded to the lid 30 over the entire circumference to hermetically seal between the sealing member 39 and the lid 30.

In an initial charging and aging step S6, a charging device (not shown) is connected to the battery 1 to initially charge the battery 1. Then, this initially charged battery 1 is left to stand for a predetermined time to age the battery 1. Thus, the battery 1 is completed.

The method for producing the battery 1 of the present embodiment uses the lid 30 provided with the protruding strip portions 35 and 36 between the peripheral portion 31 and the insertion-hole surrounding portions 33 and 34. Accordingly, in the welding step S4, the scattered light LC of the laser beam LB is blocked by the protruding strip portions 35 and 36 and is less likely to be irradiated to the resin members 70 and 80, so that formation of the scorched portion BP on the resin members 70 and 80 can be prevented. In addition, since the protruding strip portions 35 and 36 are each formed, by forging, near the end surface 31s of the peripheral portion 31 of the lid 30, specifically, at a position with the distance D falling within 0.5t, from the end surface 31s of the peripheral portion 31 to the side surface 35ks or 36ks of the proximal portion 35k or 36k of the protruding strip portion 35 or 36, relative to the thickness t of the lid 30, the protruding strip portions 35 and 36 can be formed with high accuracy.

Furthermore, in the present embodiment, the lid 30 is provided with the protruding strip portions 35, which are located one between the long-side peripheral portions 31b and the insertion-hole surrounding portion 33 and extend along the long-side peripheral portions 31b, and the protruding strip portions 36, which are located one between the long-side peripheral portions 31b and the insertion-hole surrounding portion 34 and extend along the long-side peripheral portions 31b. This configuration can therefore prevent formation of a scorched portion BP on the peripheral proximity portions 70e and 80e, of the resin members 70 and 80, which are close to the long-side peripheral portions 31b and thus particularly apt to be formed with a scorched portion BP.

While the present disclosure has been described above based on the embodiment, it should be understood that the present disclosure is not limited to the embodiment but can be irradiated with modifications appropriately made thereto without departing from the scope of the gist of the present disclosure.

For example, the foregoing embodiment exemplifies that the pairs of protruding strip portions 35 and 36 are provided as protruding portions extending along the long-side peripheral portions 31b of the lid 30. In addition to those protruding strip portions 35 and 36, a pair of protruding strip portions (protruding portions) 37 and 38 may be provided extending along the corresponding short-side peripheral portions 31c of the lid 30 as shown by a broken line in FIG. 8A. This configuration can prevent formation of a scorched portion BP on peripheral proximity portions 70f and 80f, along the short-side peripheral portions 31c, of the resin members 70 and 80. Similar to the protruding strip portions 35 and 36, these protruding strip portions 37 and 38 may also each be formed, by forging, near the end surface 31s of the peripheral portion 31 of the lid 30, specifically, at a position with a distance D from the end surface 31s of the peripheral portion 31 to a side surface 37ks or 38ks of a proximal portion 37k or 38k of the protruding strip portion 37 or 38 being within 0.5t relative to the thickness t of the lid 30.

In the embodiment, the laminated electrode body 40 is exemplified as the electrode body housed in the case 10, but the electrode body may be a flat wound electrode body. In a single case, a plurality of electrode bodies may be housed together.

### REFERENCE SIGNS LIST

1 Battery (Power storage device)
7 Lid assembly
10 Case
20 Case body
21 Opening portion
21b Long-side opening portion
21c Short-side opening portion
30 Lid
30Z Lid (with no protruding strip portion)
31 Peripheral portion
31b Long-side peripheral portion
31c Short-side peripheral portion
31s End face
33, 34 Insertion-hole surrounding portion
33h, 34h Insertion hole
33e, 34e Long-side surrounding portion
33f, 34f Short-side surrounding portion
35, 36, 37, 38 Protruding strip portion
35k, 36k, 37k, 38k Proximal portion (of Protruding strip portion)
35ks, 36ks, 37ks, 38ks Side surface (of Peripheral portion of proximal portion)
40 Electrode body
50, 60 Terminal member
70, 80 Resin member
70e, 80e Peripheral proximity portion (of a resin member, located proximate to a long-side peripheral portion of a lid)
70f, 80f Peripheral proximity portion (of a resin member, located proximate to a short-side peripheral portion of a lid)
DH Lid thickness direction
DH1 Outer side (in lid thickness direction)
LB Laser beam
LC Scattered light
BP Scorched portion
S1 Lid forming step
S11 Punching step
S12 Protruding portion forming step
S2 Lid assembly forming step
S3 Closing step
S4 Welding step
S5 Liquid injecting and sealing step
S6 Initial charging and aging step

What is claimed is:

1. A method for producing a power storage device,
the power storage device including:
a case including a bottomed tube-shaped case body having an opening portion, and a lid that is laser-welded to the case body over an entire circumference and closes the opening portion,
a terminal member inserted in an insertion hole that penetrates through the lid in a lid thickness direction, and
a resin member joined to the terminal member and joined to an insertion-hole surrounding portion of the lid, which surrounds the insertion hole, while insulating between the insertion-hole surrounding portion of the lid and the terminal member,
wherein the method comprises:
forming the lid;
forming a lid assembly that includes the lid and the terminal member integrated with the lid via the resin member, by forming the resin member by insert-molding in a state where the terminal member is inserted in the insertion hole of the lid;
closing the opening portion of the case body with the lid of the lid assembly; and
laser-welding the opening portion of the case body and a peripheral portion of the lid over the entire circumference to form the case by irradiating a laser beam from an outer side in the lid thickness direction of the lid,
wherein forming the lid comprises:
using forging,
forming a protruding portion between the peripheral portion and the insertion-hole surrounding portion of the lid so as to protrude toward the outer side in the lid thickness direction to block scattered light of the laser beam irradiated to the opening portion and the peripheral portion from being irradiated to the resin member,
such that the protruding portion is located at a position with a distance D from an end surface of the peripheral portion to a side surface of a proximal portion of the protruding portion on the peripheral portion side falling within 0.5t (D≤0.5t), relative to a thickness t of the lid.

2. The method for producing the power storage device according to claim 1, wherein
the opening portion of the case body has a rectangular ring shape including a pair of long-side opening portions and a pair of short-side opening portions,
the peripheral portion of the lid has a rectangular ring shape including a pair of long-side peripheral portions and a pair of short-side peripheral portions,
in closing the opening portion, the lid is placed to close the opening portion of the case body so that the pair of long-side peripheral portions of the lid faces the pair of long-side opening portions of the case body and the pair of short-side peripheral portions of the lid faces the pair of short-side opening portions of the case body, and
the protruding portion includes a pair of protruding strip portions located one by one between the pair of long-side peripheral portions and the insertion-hole surrounding portion of the lid, the protruding strip portions extending along the long-side peripheral portions.

3. A power storage device comprising:
a case including a bottomed tube-shaped case body having an opening portion, and a lid that is laser-welded to the case body over an entire circumference and closes the opening portion;
a terminal member inserted into an insertion hole that penetrates through the lid in a lid thickness direction; and
a resin member joined to the terminal member and joined to an insertion-hole surrounding portion of the lid, which surrounds the insertion hole, while insulating between the insertion-hole surrounding portion of the lid and the terminal member,
wherein the lid includes a protruding portion which is located between a peripheral portion and the insertion-hole surrounding portion of the lid, which protrudes toward an outer side in the lid thickness direction, which blocks scattered light of a laser beam irradiated to the opening portion and the peripheral portion from being irradiated to the resin member, and which is formed by forging such that a distance D of the protruding portion from an end surface of the peripheral portion to a side surface of a proximal portion of the protruding portion on the peripheral portion side is within 0.5t (D≤0.5t) with respect to a thickness t of the lid, and
the resin member has been prevented by the protruding portion of the lid from formation of a scorched portion.

4. The power storage device according to claim 3, wherein
the opening portion of the case body has a rectangular ring shape including a pair of long-side opening portions and a pair of short-side opening portions,
the peripheral portion of the lid has a rectangular ring shape including a pair of long-side peripheral portions and a pair of short-side peripheral portions,
the protruding portion includes a pair of protruding strip portions located one by one between the pair of long-side peripheral portions and the insertion-hole surrounding portion of the lid, the protruding strip portions extending along the long-side peripheral portions, and
the resin member has been prevented by the protruding strip portions of the lid from formation of a scorched portion at peripheral proximity portions, which are close to the long-side peripheral portions.
